(19) United States
(12) Patent Application Publication
(10) Pub. No.: US 2011/0229601 A1
(43) Pub. Date: Sep. 22, 2011

(54) CHEWING GUM CONTAINING LOW DOSE AMOUNTS OF WATER SOLUBLE VITAMINS

(75) Inventors: Michael W. Dodds, La Grange Park, IL (US); Darci C. Chidichimo, Crown Point, IN (US); Michael J. Greenberg, Northbrook, IL (US)

(73) Assignee: WM. WRIGLEY JR. COMPANY, Chicago, IL (US)

(21) Appl. No.: 13/121,164

(22) PCT Filed: Oct. 5, 2009
(86) PCT No.: PCT/US09/59487

§ 371 Date: Apr. 22, 2011

Related U.S. Application Data
(60) Provisional application No. 61/102,895, filed on Oct. 6, 2008.

(51) Int. Cl. A23L 1/302; A23G 4/18

(52) U.S. Cl. 426/2; 426/72; 426/5

(57) ABSTRACT

Chewable compositions containing at least 20% of recommended daily allowance of water-soluble vitamins are used to maintain a beneficial amount of such vitamins in a consumer's bloodstream throughout a day. Use of such chewable compositions may be supplemented by additional single dose intake of such water-soluble vitamins.

### BACKGROUND OF THE INVENTION

This invention relates to chewable compositions and more particularly relates to chewing gum compositions containing reduced amounts of water-soluble vitamins useful for maintenance of health beneficial levels of such water-soluble vitamins in a consumer throughout the day.

In general, vitamins and minerals are required for normal growth, maintenance, and functioning of the body. The vitamin requirement of the body for basic functioning usually is adequately supplied by a balanced diet. A vitamin deficiency can result in a condition referred to as hypovitaminosis and, in more severe circumstances, result in disease referred to as avitaminosis. Both can occur not only as a consequence of insufficient supply of vitamins by food intake, but can be caused by disturbances in resorption, by stress, and by disease. Consumption of dietary supplements may be used to alleviate potential effects caused by poor diet, and decrease ill effects which certain highly reactive oxygen and nitrogen containing molecules have in the body.

Dietary supplements in daily dosage forms are common and provide the recommended daily allowance (RDA) for many vitamins and minerals in a single dosage form, and are often intended for use once a day. Currently preferred methods for the administration of dietary supplements include single vitamin or mineral formulations, multi-vitamin formulations, multi-vitamin formulations with added minerals, and multi-vitamin formulations with antioxidants. These formulations often take the form of tablets, effervescent tablets, chewable tablets, capsules, oils and drinks.

Many dietary supplements currently available for use are not optimally efficacious as they do not provide an optimal vehicle of delivery and dose. Supplements are often difficult to swallow, create gastric upset, and can cause tooth enamel erosion. Additionally, such supplements only provide a single dose which cannot be fully absorbed and used by the body throughout the day, and thus cannot be maintained in the bloodstream for optimal efficacy and health benefits.

Intake of water-soluble vitamins such as vitamin C and the B vitamins is beneficial to human health. In fact, many persons supplement natural consumption of essential vitamins, minerals, and other substances required in relatively low doses for health by consuming pills or similar forms containing such vitamins and minerals, usually with concurrent drinking of a liquid. Typically, such pills or similar forms are taken daily in a single dose. As a result the amount of supplemental vitamins and minerals are present to satisfy a recommended daily allowance (RDA) as established by recognized health organizations.

For some vitamins, such as Vitamin C, ingesting a large amount of such vitamin in one dose is not effective to assure a suitable concentration of such vitamin throughout a full day. This is due to the body's rapid elimination of some water-soluble vitamins through natural processes. Although it is possible to ingest multiple lesser amounts of vitamin C throughout a day, some persons may not be able to follow such a regimen because of unavailability of means to ingest a pill together with a liquid.

A vitamin delivery system, including a chewable composition containing a suitable water-soluble vitamin (such as vitamin C or a B vitamin) in an amount which is less than RDA of such vitamin, which may be used multiple times in a day, provides an effective health benefit concentration of such vitamin in a body throughout a day. Such a delivery system does not require availability of a liquid to consume a pill or similar form, but does provide a convenient and pleasurable method of maintaining an effective concentration of such vitamin in the body. Further, a vitamin delivery system which provides lesser amounts of a vitamin throughout a day avoids consuming a large single dose of such vitamin most of which is eliminated from the body without providing a heath benefit effect.

Accordingly, it would be desirable to provide a dietary supplement which overcomes such deficiencies.

### SUMMARY OF THE INVENTION

Chewable compositions containing at least 20% of recommended daily allowance of water-soluble vitamins are used to maintain a beneficial amount of such vitamins in a consumer's bloodstream throughout a day. Use of such chewable compositions may be supplemented by additional single dose intake of such water-soluble vitamins.

### BRIEF DESCRIPTION OF THE DRAWING

FIG. 1 is a graph which demonstrates changes in blood plasma vitamin C levels over time after consumption of chewing gums containing vitamin C.

### DESCRIPTION OF THE INVENTION

It is thought that vitamins, antioxidants and minerals are beneficial in treating, inhibiting, or preventing a variety of diseases, disorders, conditions or ailments by supplementing the body's natural defenses.

Chewable compositions of this invention provide a means to maintaining efficacious levels of water soluble vitamins in the bloodstream of a consumer throughout the day in addition to diet and diet supplements. In general, a dietary supplement is a product taken by mouth that contains a “dietary ingredient” intended to supplement the diet. The dietary ingredients in these products may include vitamins, minerals, herbs or other botanicals, amino acids, and substances such as enzymes, organ tissues, glandulars, and metabolites. Dietary supplements also can be extracts or concentrates, and may be found in many forms such as tablets, capsules, softgels, gelcaps, liquids, or powders. They can also be in other forms, such as a bar, but if they are, information on their label must not represent the product as a conventional food or a sole item of a meal or diet. Additionally, the term dietary ingredient is considered to be a component of a dietary supplement. In order for an ingredient of a dietary supplement to be a “dietary ingredient,” it must be one or any combination of the following substances: vitamins, minerals, herbs or botanicals, an amino acid, a dietary substance for use by man to supplement the diet by increasing the total dietary intake (e.g., enzymes or tissues from organs or glands), or a concentrate, metabolite, constituent or extract.

The term “efficacious” means producing or capable of producing a desired effect. When used in respect to an “effective amount” the term refers to the level, amount, serving, or percent that is required to produce or is capable of producing a desired effect.

All percentages used herein are by weight of the total composition and all measurements made are at 25° C., unless otherwise designated.

Blood is a specialized biological fluid (technically a tissue) consisting of red blood cells (also called RBCs or erythrocytes), white blood cells (also called leukocytes) and platelets (also called thrombocytes) suspended in a complex fluid medium known as blood plasma. The term “blood” also includes bloodstream and blood plasma. Blood plasma is the liquid component of blood, in which the blood cells are suspended. Blood plasma makes up about 55% of total blood volume.

Preferably, the chewable composition of this invention eliminates a need for having fluids available for swallowing large pills, and is gentler on the stomach. This is particular helpful for those having difficulty in swallowing and for those having gastrointestinal difficulties.

As used herein, “chewable compositions” refers to a variety of forms which are chewed in the mouth after oral administration or slowly dissolve after oral administration. In a preferred aspect, the chewable compositions of the present invention are retained in the oral cavity for a period of time greater than one minute.

The chewable compositions of this invention may be in the form of a lozenge, chewing gum, pastille, nougat, toffee, bioadhesive, biodisc, bead, film or tablet that can be chewed, sucked, or adhered to oral tissues, allowing for increased residence time in the oral cavity thereby allowing more complete release and absorption of the water soluble vitamins into the oral and/or buccal cavities. The chewable compositions may be coated by a variety of materials including but not limiting to sugars, polyols, chocolates, syrups, films, and the like. The chewable composition may be mounted on a stick in a variety of different shapes. Upon release of an efficacious amount of a water soluble vitamin from chewable composition into the oral and/or buccal cavities, the chewable composition may be expectorated from the mouth, dissolved in the mouth, or swallowed for digestion in the gut. The chewable composition contains water-soluble vitamins, but may also additionally contain water-insoluble vitamins, minerals, antioxidants and the like.

In accordance with this invention, a consumer consumes a chewable composition by placing such composition in the consumer's mouth and permits the consumer's natural saliva to dissolve or extract a water-soluble vitamin contained in the chewable composition. A consumer may actively masticate (chew) or suck the composition or passively permit the composition to dissolve. Such chewable composition is consumed in a consumer's mouth for a period of time (referred to as the “oral residence time”) during which the water-soluble vitamin continues to be dissolved or extracted from the chewable composition. Typical oral residence times are from 0.5 minute (preferably at least one minute) and may extend up to ten minutes or more. A typical oral residence time is 1 to 5 minutes. The preferable method of consuming a chewable composition according to this invention is by actively chewing the composition.

Non-limiting examples of the present invention can take any physical form suitable for application to an oral surface and provides either a cosmetic prophylactic or therapeutic benefit within or derived from the oral cavity. In various embodiments, the oral composition can be a dentifrice such as a powder, spray or foam; an edible film or a bioadhesive film; a confectionary composition including but not limiting to breath mints, liquid filled beads, low boiled candy, chewing gum, chewy candy, hard boiled candy, coated candy, lozenges, syrups, pressed mints, chocolates and the like. In certain embodiments, the consuming, masticating or adhering of the oral composition is repeated at regular intervals. The preferable chewable composition useful in this invention is chewing gum.

A vitamin or vitamin derivative is a compound that is a vitamin and/or has vitamin-like activity, including natural and synthetic vitamins as well as vitamin analogs, derivatives, precursors, esters, salts, isomers, racemates, enantiomers, tautomers and the like. A source of a vitamin herein can be the vitamin itself, or a vitamin or vitamin derivative that upon administration to an oral surface generates or releases the vitamin on the oral surface and/or in the underlying tissue to exhibit antioxidant activity characteristic of the vitamin. A “multivitamin or vitamin complex” means a plurality of vitamin or vitamin derivatives.

Multiple low doses throughout the day are more beneficial than once a day single dosages. The chewable compositions provided herein allow for three or more servings per day, and may be chewed in the mouth after oral administration, or slowly dissolve after oral administration at least every 60, 90, or 120 minutes. The chewable compositions may be consumed in the daytime or in the nighttime, but most preferably before or after consumption of a once a day dietary vitamin supplement, throughout the day.

The chewable compositions of the present invention may employ a variety of release mechanisms of the water-soluble vitamin, which include delayed, immediate, timed, controlled and variable, alone or in combination using known procedures in the art. In an aspect of the invention, the chewable compositions may utilize the process of encapsulation as a release mechanism for the water-soluble vitamin. Some examples of encapsulation procedures include but are not limited to spray drying, fluid-bed coating, spray chilling, coacervation, agglomeration, fixation, absorption, and entrapment alone or in any combination yielding full or partial encapsulation. The water-soluble vitamin or additional dietary ingredient may be coated in a two-step process or multiple step process. The materials may be coated with any of the ingredients as described herein to obtain a coated product yielding improved crunch, sensory properties and/or stability.

Water soluble vitamins useful in this invention include vitamin C and B vitamins. Typically B vitamins useful in this invention include vitamin B1 (Thiamine), vitamin B2 (Riboflavin), vitamin B6, Nicotinamide, Pantothenic Acid, Biotin, Folic Acid, and vitamin B12, and combinations thereof. Examples of these vitamins together with recommended daily allowances are provided in Table 1.

TABLE 1

| | | RDA¹ | Disease Associated With | Upper | |
|---|---|---|---|---|---|
| | Chemical Name | (mg/day) | Deficiency of Vitamin | Intake/Day | |
| Vitamin B₁ | Thiamine | 1.2 | Beriberi | N/D² | |
| Vitamin B₂ | Riboflavin | 1.3 | Ariboflavinosis | N/D | |
| Vitamin B₃ | Niacin, niacinamide | 16.0 | Pellagra | 35.0 | mg |
| Vitamin B₅ | Pantothenic acid | 5.0 | Paresthesia | N/D | |
| Vitamin B₆ | Pyridoxine, pyridoxamine, | 1.3-1.7 | Anaemia^{[19]} | 100 | mg |
| | pyridoxal | | | | |
| Vitamin B₇ | Biotin | 30.0 | Dermatitis, enteritis | N/D | |
| Vitamin B₉ | Folic acid, folinic acid | 400 | Deficiency during pregnancy | 1,000 | μg |
| | | | is associated with birth | | |
| | | | defects, such as neural tube | | |
| | | | defects | | |
| Vitamin B₁₂ | Cyanocobalamin, | 2.4 | Megaloblastic anaemia^{[20]} | N/D | |
| | hydroxycobalamin, | | | | |
| | methylcobalamin | | | | |
| Vitamin C | Ascorbic acid | 90.0³ | Scurvy | 2,000 | mg |

¹Recommended Daily Allowance
²Not Determined
³For adult men; 75 mg for adult women; smokers should add 35 mg

Vitamin C as described herein refers to any derivative, compound, or combination of compounds having vitamin C activity. Except where the context demands otherwise, the term “vitamin C” is used generically herein to encompass ascorbic acid, any of its salts, any of its derivatives from natural or artificial sources, including any enantiomer or racemate thereof, and any mixture of such compounds having vitamin C activity.

Non-limiting examples of vitamin C derivatives include calcium ascorbate, magnesium ascorbate, zinc ascorbate, potassium ascorbate, sodium ascorbate, dehydroascorbic acid, L-ascorbic acid 2-0-sulfate, L-ascorbic acid 2-0-phosphate, L-ascorbic acid 3-0-phosphate, L-ascorbic acid 6-hexadecanoate, L-ascorbic acid monostearate, L-ascorbic acid dipalmitate, L-threonic acid, L-xylonic acid, L-lyxonic acid and combinations thereof.

The presence of vitamin C (ascorbate) is required for a range of essential metabolic reactions in all animals and plants. It is made internally by almost all organisms, humans being the most well-known exception. It is widely known as the vitamin whose deficiency causes scurvy in humans, and also a widely known food additive. The pharmacophore of vitamin C is the ascorbate ion. In living organisms, ascorbate is an antioxidant, since it protects the body against oxidative stress and is a cofactor in several vital enzymatic reactions.

Because vitamin C is water soluble, it is quickly excreted; with an inadequate daily intake of vitamin C, the body's store of vitamin C is depleted at a rate of about 3 percent each day. In contrast, too much vitamin C can be toxic, causing cramps, nausea and diarrhea. While vitamin C plays an essential role as an antioxidant, the acidic nature of many current vitamin C supplements, particularly those containing ascorbic acid, generally leads to gastrointestinal problems, such as dyspepsia, gastric upset and diarrhea and teeth problems. Thus, to maintain an adequate and efficacious supply of vitamin C in the bloodstream requires multiple low doses throughout the day for health benefits.

In accordance with this invention, a chewable composition contains a portion of a recommended daily allowance of a water-soluble vitamin and multiple chewable compositions are consumed by a person throughout a day in order to maintain a health beneficial amount of such water-soluble vitamin in the bloodstream of the consumer. With regard to this invention “consumption” means oral chewing, masticating, sucking, or permitting dissolution of a composition for sufficient time in order to release a desired amount water-soluble material into an oral cavity through solubilization or extraction by saliva.

In an aspect of this invention, the amount of water-soluble vitamin contained in the chewable composition is at least 20% of the RDA for such vitamin, preferably at least 25% and typically at least 30% of such RDA. The amount of such vitamin typically is up to 75% of the RDA, preferably up to 50% of RDA, and usually up to 40% of RDA.

Each chewable composition contains from about 60 milligrams per serving (mg/svg) to about 300 milligrams per serving (mg/svg), 50 mg/svg to about 150 mg/svg, or 40 mg/svg to about 200 mg/svg of water soluble vitamin such that multiple servings may be consumed each day following consumption of a dietary supplement at least three time a day or more. As described herein, a serving size may be equivalent to one, two, three or more chewable compositions being consumed in one sitting or event as defined by the product label. In another aspect of the invention, the dietary supplement is for use once a day, or alternatively, the directions for use states “take one capsule daily”, and the chewable composition is administered at least three or more times in a twenty-four after consumption of the once a day supplement.

For example, the water-soluble vitamin may be present in a chewable composition at a concentration of from about 0.001% to about 20% by weight, from about 0.001% to about 10% by weight, from about 0.01% to about 5% by weight, or from about 0.1% to about 1% by weight. Alternatively, the chewable composition contains at least 20 mg to about 50 mg per matrix, 25 mg to about 60 mg per matrix or 30 mg to about 125 mg per chewable composition. As described herein, a matrix is equivalent to one chewable composition.

The chewable composition preferably contains a water-soluble vitamin such as vitamin C in the range of about 20 mg to about 125 mg, depending on the desired level needed each day for beneficial treatment, mediation, or prevention of diseases, disorders or conditions. In another aspect, the vitamin C may be present in at a concentration in milligrams per serving (mg/svg) of at least about 20.0 mg/svg at least about 40.0 mg/svg, at least about 60.0 mg/svg, at least about 80.0 mg/svg, or more. Still further, in an aspect of the invention, vitamin C may be present in a chewable composition at a concentration of from about 0.001% to about 20% by weight, from about 0.001% to about 10% by weight, from about 0.01% to about 5% by weight, or from about 0.1% to about 1% by weight.

In accordance with this invention, a person typically consumes a chewable composition at least three times in a day, although a typical person may consume such composition up to five times per day or more. Typically, the amount of water-soluble vitamin in the chewable composition is selected as to not exceed a recommended maximum amount of such vitamin in a day, even if a person consumes more than four such compositions per day.

In another aspect of this invention, consumption of chewable compositions containing a water-soluble vitamin is supplemented by a conventional single dose dietary supplement such as in pill or tablet form. Such single dose may be taken in the morning upon awaking or in the evening before sleep. A preferable regimen in accordance with this invention is consuming chewable compositions during waking time and taking a supplemental dose before sleep. In this regimen, a beneficial level of a vitamin is maintained during a majority of sleeping time.

In an aspect of the invention, the chewable composition is in the form of a chewing gum or a chewable tablet which is taken at multiple intervals throughout the day after consumption of a daily dietary supplement. In another aspect, the chewable composition is in the form of a bioadhesive disc adhering to oral mucosal tissues, containing at least 20 mg of vitamin C, thereby leaching vitamin C as the biodisc dissolve in the mouth. This allows for a slow and constant release of vitamin C, and its quick uptake into the bloodstream of a consumer after the consumer has already administered a once a day dietary supplement containing at least 50 mg of vitamin C.

For example, vitamin C from a chewing gum or chewable tablet can be delivered to the blood plasma faster and more completely than swallowing a tablet containing the same level of vitamin C. Often, many dietary supplements require that the supplement be consumed with food to aid in absorption of the actives from the gut. In addition, once the vitamin C reaches the bloodstream and peaks, the amount rapidly declines due to its solubility and quickly gets excreted from the body. Thus, in an embodiment, it is beneficial to administer a chewable composition of the present invention before the blood loses more than 0.2 mg/deciliter of vitamin C in order to maintain elevated levels of vitamin C for optimal health benefits to a consumer. The matrices of the present invention do not require food or drink for administration or uptake into the bloodstream.

In another aspect, the water-soluble vitamin may include alone or in combination, Thiamine (vitamin B₁), Riboflavin (vitamin B₂), Pyridoxine (Pyridoxal, vitamin B₆), Nicotinamide (Niacin), Pantothenic Acid, Biotin, Folic Acid, and Cyanocobalamin (vitamin B₁₂).

Surprisingly, the inventors of the present invention have found that multiple low dose vitamin C in chewing gums taken daily to maintain and increase blood plasma levels of vitamin C perform better than taking a single bolus dose once a day (as in a once a day daily supplement). Without being bound to any particular theory, the inventors of the present invention believe that maintaining elevated levels in the blood over a 24-hour period allow for constant antioxidant activity thus aiding in the treatment, inhibition, or prevention of a variety of diseases, disorders, conditions or ailments by supplementing the body's natural defenses.

The present invention provides matrices containing appropriate levels of vitamin C which are used in combination with a daily supplement to maintain efficacious levels in the bloodstream throughout the day without accompanying side effects generally associated with single, large doses of vitamin C supplementation or the need for food or beverages to facilitate absorption from the gut.

In a preferred embodiment, the oral composition is a chewing gum composition which is suitable for chewing and which comprises 2% or greater, by weight of the composition, of elastomer. In general, chewing gum compositions are chewed or masticated by consumers, the process by which food is mashed and crushed by teeth. Such chewing gum compositions can take a variety of shapes and forms, for example, a pellet, a gumball, a square, a stick, etc., and may be coated by a variety of materials including but not limiting to sugars, polyols, chocolates, syrups, films, etc., alone or in any combination.

Interestingly, the inventors of the present invention believe that chewing gums with lower doses of sodium ascorbate and/or ascorbic acid (vitamin C) have a tendency to lose more ascorbate over shelf life. Also, sodium ascorbate employed in the coating of a chewing gum composition appears to be lost in a different manner than sodium ascorbate employed in a stick or in the center of a coated chewing gum product. The sodium ascorbate applied in the water insoluble portion of a chewing gum tends to lose the majority of ascorbate when the product is made, while the coating loses it more so during shelf life.

The present methods allow normal levels of vitamin C to be established and maintained in the body throughout the day without an accompanying increase in side effects.

In another aspect of this invention, a system useful in assisting administering the chewable compositions of this invention comprises a package containing a single dose of at least one water-soluble vitamin supplement and at least three chewable compositions as described in this invention containing 20 to 50% of the recommended daily allowance (RDA) of a water-soluble vitamin such as vitamin C, a B vitamin, or combinations thereof. Preferably the chewable composition is a chewing gum with each gum portion separately wrapped. In another aspect of this invention, such single dose is in the form of a chewable composition such as a chewing gum, which contains at least the RDA of such water-soluble vitamin. A kit or package containing such a system includes a single dose supplement together with multiple chewable compositions containing less than the RDA (such as 20 to 50% or such RDA) for the water-soluble vitamins incorporated within such compositions. In an aspect of such a kit or package, a single-dose supplement is in the form of a chewable composition (preferably a chewing gum) which is distinctive from the other chewable compositions in the kit. Such distinction may be a color or shape of the composition, wrapper or covering on such composition, or combinations thereof.

The following examples are illustrative of preferred embodiments of the invention and are not to be construed as limiting the invention thereto. All percentages are based on the percent by weight of the composition unless otherwise indicated and all totals equal 100% by weight.

I. ORAL COMPOSITIONS

Chewable composition includes chewing gums, and orally soluble tablets, bead, lozenges, bioadhesives and films. Saliva dissolves the lozenge or chewable gum product, and promotes prolonged contact with oral surfaces so that the delivery of the water soluble vitamin in a lozenge, tablet, bead, chewing gum, chewy candy, liquid filled bead, bioadhesive or film to ensure adequate dosage and delivery of water-soluble vitamin. Ideally, the chewable composition of the present invention is capable if being retained in the mouth for a period of time greater than 30 seconds to allow for complete release and absorption of the water soluble vitamin by the oral mucosa and/or buccal tissues.

In a preferred embodiment, the oral composition is a chewing gum composition which is suitable for chewing and which comprises 2% or greater, by weight of the composition, of elastomer. In general, chewing gum compositions are chewed or masticated by consumers, the process by which food is mashed and crushed by teeth. Such chewing gum compositions can take a variety of shapes and forms, for example, a pellet, a gumball, a square, a stick, and the like, and may be coated by a variety of materials including but not limiting to sugars, polyols, chocolates, syrups, films, and the like., alone or in any combination.

The chewing gum of the present invention is preferably a sugarless chewing gum containing water-soluble vitamins. Chewing gum formulations typically contain, in addition to, a chewing gum base, one or more plasticizing agents, at least one sweetening agent and at least one flavoring agent.

Gum base materials suitable for use in the practice of this invention are well known in the art and include natural or synthetic gum bases or mixtures thereof. Representative natural gums or elastomers include chicle, natural rubber, jelutong, balata, guttapercha, lechi caspi, sorva, guttakay, crown gum, perillo, or mixtures thereof. Representative synthetic gums or elastomers include butadiene-styrene copolymers, polyisobutylene and isobutylene-isoprene copolymers. The gum base is incorporated in the chewing gum product at a concentration of about 10 to about 40% and preferably about 20 to about 35%.

Plasticizing/softening agents commonly used in chewing gum compositions are suitable for use in this invention, including gelatin, waxes and mixtures thereof in amounts of about 0.1 to about 5%. The sweetening agent ingredient used in the practice of this invention may be selected from a wide range of materials, and include the same artificial and polyol sweeteners used for the preparation of tablets, beads and lozenges. Polyol sweeteners such as sorbitol and maltitol are present in the chewing gum composition of the present invention in amounts of about 40 to about 80% and preferably about 50 to about 75%. The artificial sweetener is present in the chewing gum composition of the present invention in amounts of about 0.1 to about 2% and preferably about 0.3 to about 1%.

The orally acceptable vehicle or carrier in a lozenge, bead, or tablet, is a non-cariogenic, solid water-soluble polyhydric alcohol (polyol) such as mannitol, xylitol, sorbitol, maltitol, hydrogenated starch hydrolysate, hydrogenated glucose, hydrogenated disaccharides or hydrogenated polysaccharides, in an amount of about 85 to about 95% of the total composition. Emulsifiers such as glycerin, and tableting lubricants, in minor amounts of about 0.1 to 5%, may be incorporated into the tablet, bead or lozenge formulation to facilitate the preparation of the tablet beads and lozenges. Suitable lubricants include vegetable oils such as coconut oil, magnesium stearate, aluminum stearate, talc, starch, and polyethylene glycols. Suitable noncariogenic gums include kappa carrageenan, carboxymethyl cellulose, hydroxyethyl cellulose and the like.

The lozenge, bead, or tablet, may optionally be coated with a coating material such as waxes, shellac, carboxymethyl cellulose, polyethylene/malic anhydride copolymer or kappa-carrageenan to further increase the time it takes the tablet or lozenge to dissolve in the mouth. The uncoated tablet or lozenge is slow dissolving, providing a sustained release rate of active ingredients of about 3 to 5 minutes. Accordingly, the solid dose tablet, bead and lozenge compositions of this embodiment affords a relatively longer time period of contact of the teeth in the oral cavity with the water-soluble vitamins of the present invention.

Bioadhesive films, syrups, sprays, microspheres, tablets, or films may also be employed. The bioadhesive polymers of this invention may be cross-linked by cross-linking agents as known in the art. Other suitable polymers include but are not limited to polyacrylic polymers, cellulose derivatives such as hydroxypropylmethylcellulose (HPMC), hydroxyethylcellulose (HEC), hydroxypropylcellulose (HPC) and sodium carboxymethylcellulose (NaCMC); natural polymers such as gelatin, sodium alginate, pectin; more generally, any physiologically acceptable polymer showing bioadhesive characteristics may be used successfully to coat controlled release units.

Preferably, the chewable composition also includes a trigeminal stimulant to provide hot, cold, tingling or irritating effects in the oral cavity of a consumer thereby increasing uptake of water-soluble vitamins to provide oral health benefits.

In a preferred embodiment, the oral composition comprises a trigeminal stimulant including but not limited to menthol and other cooling compounds such as WS-23 and other cooling carboxamide compounds. Other trigeminal stimulants include but are not limited to, camphor, allyl isothiocyanate, capsaicin, diallyl sulfide alone or in combination.

### EXAMPLE 1

Chewing gum formulations (designated “Compositions A, B, C & D”) are prepared containing a water-soluble vitamin for use after consumption of a dietary supplement.

| | A | B | C | D |
|---|---|---|---|---|
| Ingredients | Weight % | Weight % | Weight % | Weight % |
| Gum Base | 26.34 | 27.95 | 23.50 | 26.34 |
| Sorbitol | 60.00 | 54.00 | 54.95 | 60.00 |
| Mannitol | 1.00 | — | 3.00 | 1.00 |
| Lycasin/Glycerin | 8.44 | 8.50 | 10.00 | 8.44 |
| Sweetener | 0.80 | 0.80 | 0.80 | 0.80 |
| Flavor | 1.75 | 1.75 | 1.75 | 1.75 |
| Sodium Ascorbate | 1.67 | — | 1.00 | — |
| Vitamin B₆ | — | — | 1.00 | 1.67 |
| Ascorbic Acid | — | 6.00 | 4.00 | — |

### EXAMPLE 2

Example 2 demonstrates water-soluble multiple dose loading level in chewable compositions of the present invention for repeat administration of a water-soluble vitamin in a 24-hour period after intake of a daily dietary supplement.

Water soluble vitamin multiple dose loading levels

| | 200 mg/day | | 300 mg/day | | 400 mg/day | | 500 mg/day | |
|---|---|---|---|---|---|---|---|---|
| 3 dose/day | 66.7 | mg/serving | 100 | mg/serving | 200 | mg/serving | 250 | mg/serving |
| | 33.3 | mg/matrix | 50 | mg/matrix | 100 | mg/matrix | 125 | mg/matrix |
| 4 dose/day | 50 | mg/serving | 75 | mg/serving | 100 | mg/serving | 125 | mg/serving |
| | 25 | mg/matrix | 37.5 | mg/matrix | 50 | mg/matrix | 62.5 | mg/matrix |
| 5 dose/day | 40 | mg/serving | 60 | mg/serving | 80 | mg/serving | 100 | mg/serving |
| | 20 | mg/matrix | 30 | mg/matrix | 40 | mg/matrix | 50 | mg/matrix |

II. DATA

### Test A

A double blind, parallel test design was conducted at Our lady of Mercy of

Medical Center in Bronx, N.Y. to test the efficacy an release of a water soluble vitamin, vitamin C, in reducing the biomarker associated with inflammation from a chewing gum composition. In particular, the study provides support for using vitamin C in a chewing gum composition for decreasing plasma c-reactive protein (CRP), a major risk factor for cardiovascular disease.

There were 83 participants in the study. There were 28 volunteers in each of the experimental groups and 27 in the control group.

### Study Design

Three test groups.
Placebo (grapefruit flavor with citric acid to match acidity of vitamin C groups)
Vitamin C only (grapefruit flavor with 182 mg/svg of Vitamin C)
The gum blend (grapefruit flavor with 190 mg/svg of Vitamin C, 25 mg/svg of Green Tea Extract, 6.2 mg/svg of Gallic Acid)

Each group participated in the study for a total of 12 weeks and was instructed to chew two chewing gum pellets three times a day to deliver a daily dose of 500 mg of Vitamin C,

Baseline measurements of plasma levels of Vitamin C, CRP, cotinine and MDA (oxidized LDL) were measured. After 6 weeks, Vitamin C levels and CRP were measured in the plasma. And after 12 weeks, plasma levels of Vitamin C, CRP and MDA were measured.

### Results

A significant decrease in plasma CRP occurred when chewing the vitamin

C gum for 6 weeks (p<0.0005). Further, there was a significant decrease in CRP levels from 6-12 weeks. Plasma CRP significantly increased over the 12 weeks in the control group.

Plasma vitamin C levels doubled after 6 weeks and after 12 weeks showed a further increase. Overall, values increased from about 0.6 to 1.6 mg/dl in the vitamin C group, while the placebo group showed no change from baseline. During the 12 weeks, plasma ascorbic acid levels increased 168% in the vitamin C group and only 3.7% in the placebo group.

The results were further separated into groups based on baseline levels of CRP and this was according to AHA designated CRP levels of low risk, average risk and high risk. Results are charted below in Table 2.

TABLE 2

| | Plasma C | Plasma C | Plasma C | CRP | CRP 6 | % delta 6 | CRP 12 | % delta |
|---|---|---|---|---|---|---|---|---|
| | Baseline | 6 weeks | 12 weeks | Baseline | weeks | weeks | weeks | 12 weeks |
| Variable | (mg/dl) | (mg/dl) | (mg/dl) | (mg/dl) | (mg/dl) | (mg/dl) | (mg/dl) | (mg/dl) |
| Placebo | 0.61 | 0.63 | 0.62 | 1.99 | 2.05 | 7.9 | 2.09 | 8.5 |
| Gum 500 mg | 0.61 | 1.34 | 1.63 | 2.82 | 2.32 | −12.9 | 2.04 | −20.7 |
| Vitamin C | | | | | | | | |
| (182 mg/svg, | | | | | | | | |
| 3× per day) | | | | | | | | |
| Gum with | 0.61 | 0.91 | 1.11 | | | −6 | | −10 |
| theoretical | | | | | | | | |
| 250 mg | | | | | | | | |
| Vitamin C | | | | | | | | |
| Gum Blend | 0.61 | 1.39 | 1.60 | 2.05 | 1.70 | −12.3 | 1.52 | −18.9 |
| Gum 500 | | | | | | | | |
| mg Vitamin C | | | | | | | | |
| Crp <1 | | | | | | −4.4 | | −11 |
| Crp-1-3 | | | | | | −14.7 | | −17.9 |
| Crp >3 | | | | | | −19.6 | | −31.2 |
| Gum Blend | | | | | | | | |
| Crp <1 | | | | | | −8.3 | | −10.2 |
| Crp-1-3 | | | | | | −12.7 | | −21.6 |
| Crp >3 | | | | | | −20.6 | | −31.4 |

Plasma MDA levels did not change in any of the groups over the 12 weeks.

The data demonstrate the vitamin C group provides a decrease of the inflammatory biomarker, CRP (c-reactive protein), when administered via an oral composition having oral retention capabilities such as chewing gum.

Test B

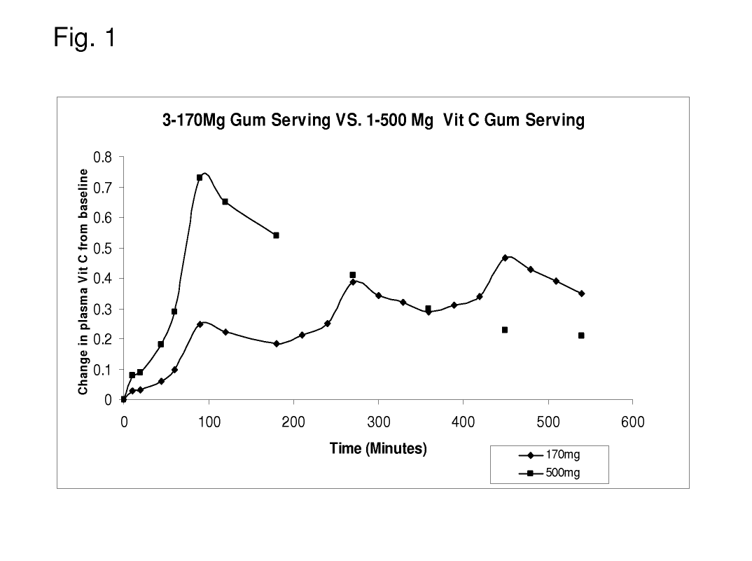

FIG. 1 demonstrates changes in blood plasma containing vitamin C over time after consumption of chewing gums containing vitamin C. The gum containing 170 mg of vitamin C was administered three times in a 550 minute period, while the gum containing 500 mg was administered only once during the same period of time.

The graph depicts rapid delivery of vitamin C into the bloodstream, but also rather loss in the 500 mg sample. In contrast, the smaller dose (170 mg) taken at repeat intervals shows a steady elevated state of vitamin C over time, thus contributing constant health benefits.

The present invention is not limited to the above embodiments and can be variously modified. The above description of the preferred embodiments, including the Examples, is intended only to acquaint others skilled in the art with the invention, its principles, and its practical application so that others skilled in the art may adapt and apply the invention in its numerous forms, as may be best suited to the requirements of a particular use.

With reference to the use of the word(s) comprise or comprises or comprising in this entire specification (including the claims below), unless the context requires otherwise, those words are used on the basis and clear understanding that they are to be interpreted inclusively, rather than exclusively, and applicants intend each of those words to be so interpreted in construing this entire specification.

What is claimed is:

1. A method for maintaining an efficacious amount of a water-soluble vitamin in the bloodstream of a person comprising consuming at least three time daily a chewable composition containing at least 20% of the recommended daily allowance (RDA) of a water soluble vitamin selected from the group consisting of vitamin C and a B vitamin.

2. A method of claim 1 wherein the chewable composition contains up to 75% of the RDA of the water soluble vitamin.

3. A method of claim 1 wherein the chewable composition has an oral residence time greater than one minute.

4. A method of claim 1, wherein the chewable composition is selected from the group consisting of chewing gums and chewable tablets.

5. A method of claim 1 wherein consumption of the chewable composition occurs more than sixty minutes after consumption of a daily dietary supplement.

6. A method of claim 1 wherein consumption a single dose dietary supplement containing a water-soluble vitamin occurs after consumption of the last chewable composition in a day and before sleep.

7. A method of claim 1 wherein consumption of the chewable compositions decreases the level of c-reactive protein (CRP) in the bloodstream of a consumer after 6 weeks.

8. A method of claim 1 wherein the water soluble vitamin is vitamin C.

9. A method of claim 1 wherein the water soluble vitamin is a B vitamin selected from the group consisting of vitamin B1 (Thiamine), vitamin B2 (Riboflavin), vitamin B6, Nicotinamide, Pantothenic Acid, Biotin, Folic Acid, and vitamin B12, and combinations thereof.

10. A method of claim 7 wherein the chewable composition is a chewing gum.

11. A method of claim 4 wherein the chewable composition is coated.

12. A chewable composition containing 20 to 75% of the recommended daily allowance of a water-soluble vitamin.

13. A chewable composition of claim 12, wherein the chewable composition is a chewy candy.

14. A chewable composition of claim 12, wherein the chewable composition is an oral bioadhesive.

15. A chewable composition of claim 12 in which the water-soluble vitamin is vitamin C or a B vitamin.

16. A water-soluble vitamin delivery system comprising a package containing a single-dose water-soluble vitamin supplement and at least three chewable compositions containing 20 to 50% of the recommended daily allowance (RDA) of a water-soluble vitamin selected from the group consisting of vitamin C and a B vitamin.

17. A system of claim 16 wherein the chewable composition is a coated chewing gum.

18. A system of claim 17 wherein the water-soluble vitamin is vitamin C.

19. A system of claim 17 wherein the water-soluble vitamin is a B vitamin selected from the group consisting of vitamin B1 (Thiamine), vitamin B2 (Riboflavin), vitamin B6, Nicotinamide, Pantothenic Acid, Biotin, Folic Acid, and vitamin B12, and combinations thereof.

20. A system of claim 17, in which the chewable composition contains 25 to 50% of the recommended daily allowance of a water-soluble vitamin.

21. A kit comprising:
a) at least one single-dose water-soluble vitamin supplement comprising at least 100% of the recommended daily allowance (RDA) of a water soluble vitamin selected from the group consisting of vitamin C and a B vitamin, and
b) at least three chewable compositions containing 20 to 50% of the recommended daily allowance (RDA) of a water-soluble vitamin selected from the group consisting of vitamin C and a B vitamin.

22. A kit of claim 21 wherein at least one of the chewable compositions is a chewing gum.

23. A kit of claim 22 wherein the single-dose chewable composition has a shape, color, or covering distinct from the chewable compositions containing 20 to 50% of the RDA of a water-soluble vitamin.

24. The kit of claim 21 wherein the kit further provides directions for use and an appropriate number of compositions for at least four weeks of treatment.
